(19) United States
(12) Patent Application Publication
(10) Pub. No.: US 2017/0188138 A1
(43) Pub. Date: Jun. 29, 2017

(54) Microphone beamforming using distance and enrinonmental information

(71) Applicant: Intel Corporation, Santa Clara, CA (US)

(72) Inventors: Kalle I. Makinen, Nokia (FI); Mikko Kursula, Lempaala (FI); David Isherwood, Tampere (FI)

(73) Assignee: Intel Corporation, Santa Clara, CA (US)

(21) Appl. No.: 14/998,094

(22) Filed: Dec. 26, 2015

(51) Int. Cl. H04R 1/32; H04R 3/00

(52) U.S. Cl. CPC H04R 1/326; H04R 3/005; H04R 2430/20

(57) ABSTRACT

An apparatus for audio beamforming with distance and environmental information is described herein. The apparatus includes a microphone or a plurality of microphones, a distance detector, a delay detector, and a processor. The distance detector is to determine a distance of an audio source from the apparatus. The delay is calculated based on the distance determined by the distance detector. The delay is determined for each of the microphones. Additionally, the processor is to perform audio beamforming of audio from the microphone array combined with a microphone specific delay applied to the audio signals from the microphones.

### BACKGROUND ART

Beamformers are typically based upon the assumption that the sound arrives to the microphone array as a planar wave. This assumption is good as long as the sound source is either far enough away from the microphone array so that the sound source acts as a point source or when the sound source naturally emits the sound as a planar wave. As used herein, a planar wave may transmit audio from an audio source such that the audio approaches the receiving microphone in a planar fashion.

### BRIEF DESCRIPTION OF THE DRAWINGS

FIG. 1 is a block diagram of an electronic device that enable audio beamforming to be controlled with video stream data;

FIG. 2 is an illustration of audio emissions from an audio source;

FIG. 3 is an illustration of beamforming error correction;

FIG. 4 is a block diagram of beamforming incorporating environmental information;

FIG. 5 is a process flow diagram of beamforming using 3D camera information; and

FIG. 6 is a block diagram showing a medium that contains logic for beamforming using distance information.

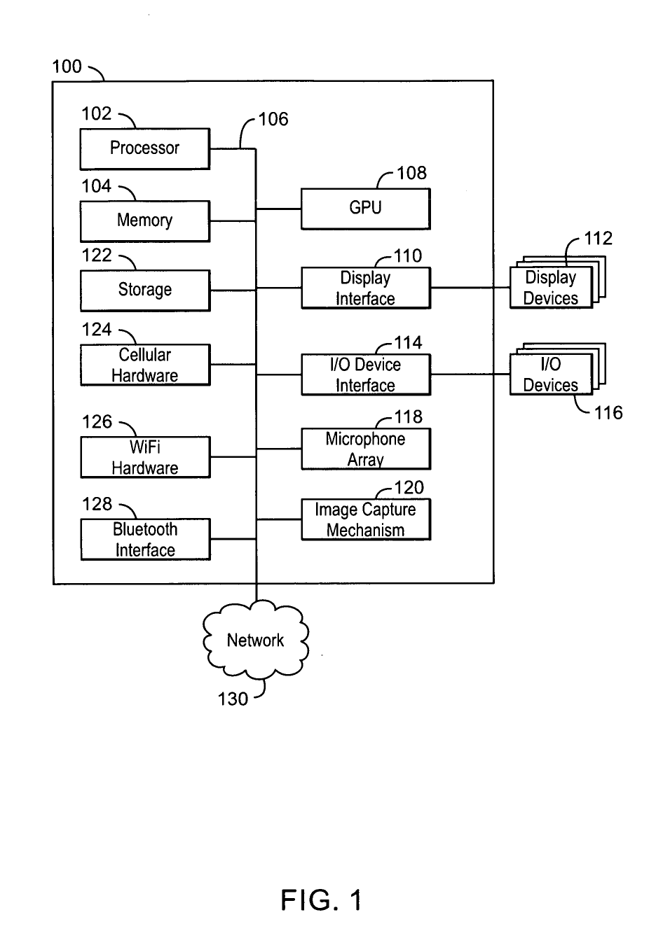

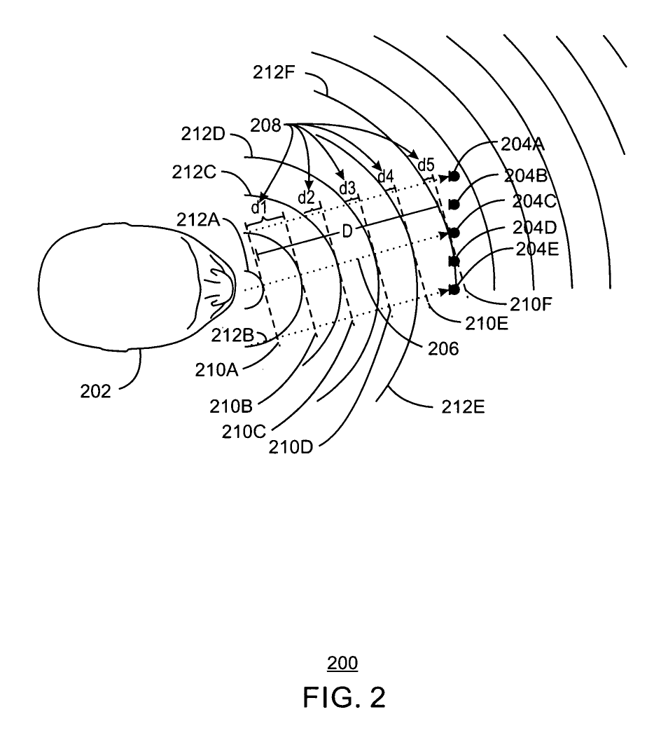

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Beamforming may be used to focus on retrieving data from a particular audio source, such as a person speaking. To enable beamforming, directionality of a microphone array is controlled by receiving audio signals from individual microphones of the microphone array and processing the audio signals in such a way as to amplify certain components of the audio signal based on the relative position of the corresponding sound source to the microphone array. For example, the directionality of the microphone array can be adjusted by shifting the phase of the received audio signals and then adding the audio signals together. Processing the audio signals in this manner creates a directional audio pattern so that sounds received from some angles are more amplified compared to sounds received from other angles. As used herein, the beam of the microphone array corresponds to a direction from which the received audio signal will be amplified the most.

As discussed above, many beamforming algorithms operate under the assumption that the sound waves are planar. However, sound waves typically are generated from an audio source as a plurality of spherical waves. By treating spherical sound waves as planar sound waves, errors may introduced into the signal processing. In particular, this error may distort or smear audio processed by the beamformer while degrading the accuracy of the beamformer.

Embodiments described herein combine a distance information and an acoustic beamformer in a manner where the distance information is utilized to correct the beamformer signal processing in order to compensate for any audio distortion or a beam smearing effect. The audio distortion most often occurs in cases when a point signal source is near the microphone array. In addition to optimizing the operation of a beamformer, the distance information can be utilized to correct the aberration caused by the unequal damping of sound frequencies in the air when propagating from the source to the microphone array. Under normal atmospheric conditions, the high frequencies of sound waves are attenuated more than the low frequencies sound waves. This attenuation becomes significantly apparent when the sound source is far, e.g., a few tens of meters, away.

Some embodiments may be implemented in one or a combination of hardware, firmware, and software. Further, some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of an electronic device that enable audio beamforming to be controlled with video stream data. The electronic device 100 may be, for example, a laptop computer, tablet computer, mobile phone, smart phone, or a wearable device, among others. The electronic device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the electronic device 100 may include more than one CPU 102. The memory device 104 can include random access memory (RAM), read only memory (ROM), flash memory, or any other suitable memory systems. For example, the memory device 104 may include dynamic random access memory (DRAM).

The electronic device 100 also includes a graphics processing unit (GPU) 108. As shown, the CPU 102 can be coupled through the bus 106 to the GPU 108. The GPU 108 can be configured to perform any number of graphics operations within the electronic device 100. For example, the GPU 108 can be configured to render or manipulate graphics images, graphics frames, videos, or the like, to be displayed to a user of the electronic device 100. In some embodiments, the GPU 108 includes a number of graphics engines, wherein each graphics engine is configured to perform specific graphics tasks, or to execute specific types of workloads. For example, the GPU 108 may include an engine that processes video data. The video data may be used to control audio beamforming.

The CPU 102 can be linked through the bus 106 to a display interlace 110 configured to connect the electronic device 100 to a display device 112. The display device 112 can include a display screen that is a built-in component of the electronic device 100. The display device 112 can also include a computer monitor, television, or projector, among others, that is externally connected to the electronic device 100.

The CPU 102 can also be connected through the bus 106 to an input/output (I/O) device interface 114 configured to connect the electronic device 100 to one or more I/O devices 116. The I/O devices 116 can include, for example, a keyboard and a pointing device, wherein the pointing device can include a touchpad or a touchscreen, among others. The I/O devices 116 can be built-in components of the electronic device 100, or can be devices that are externally connected to the electronic device 100.

Accordingly, the electronic device 100 also includes a microphone array 118 for capturing audio. The microphone array 118 can include any number of microphones, including one, two, three, four, five microphones or more. In some embodiments, the microphone array 118 can be used together with an image capture mechanism 120 to capture synchronized audio/video data, which may be stored to a storage device 122 as audio/video files. In embodiments, the image capture mechanism 112 is a camera, stereoscopic camera, image sensor, or the like. For example, the image capture mechanism may include, but is not limited to, a camera used for electronic motion picture acquisition.

The storage device 122 is a physical memory such as a hard drive, an optical drive, a flash drive, an array of drives, or any combinations thereof. The storage device 122 can store user data, such as audio files, video files, audio/video files, and picture files, among others. The storage device 122 can also store programming code such as device drivers, software applications, operating systems, and the like. The programming code stored to the storage device 122 may be executed by the CPU 102, GPU 108, or any other processors that may be included in the electronic device 100.

The CPU 102 may be linked through the bus 106 to cellular hardware 124. The cellular hardware 124 may be any cellular technology, for example, the 4G standard (International Mobile Telecommunications-Advanced (IMT-Advanced) Standard promulgated by the International Telecommunications Union-Radio communication Sector (ITU-R)). In this manner, the PC 100 may access any network 126 without being tethered or paired to another device, where the network 130 is a cellular network.

The CPU 102 may also be linked through the bus 106 to WiFi hardware 126. The WiFi hardware is hardware according to WiFi standards (standards promulgated as Institute of Electrical and Electronics Engineers' (IEEE) 802.11 standards). The WiFi hardware 126 enables the electronic device 100 to connect to the Internet using the Transmission Control Protocol and the Internet Protocol (TCP/IP), where the network 130 is the Internet. Accordingly, the electronic device 100 can enable end-to-end connectivity with the Internet by addressing, routing, transmitting, and receiving data according to the TCP/IP protocol without the use of another device. Additionally, a Bluetooth Interface 128 may be coupled to the CPU 102 through the bus 106. The Bluetooth Interface 128 is an interface according to Bluetooth networks (based on the Bluetooth standard promulgated by the Bluetooth Special Interest Group). The Bluetooth Interface 128 enables the electronic device 100 to be paired with other Bluetooth enabled devices through a personal area network (PAN). Accordingly, the network 130 may be a PAN. Examples of Bluetooth enabled devices include a laptop computer, desktop computer, ultrabook, tablet computer, mobile device, or server, among others.

The block diagram of FIG. 1 is not intended to indicate that the electronic device 100 is to include all of the components shown in FIG. 1. Rather, the computing system 100 can include fewer or additional components not illustrated in FIG. 1 (e.g., sensors, power management integrated circuits, additional network interfaces, etc.). The electronic device 100 may include any number of additional components not shown in FIG. 1, depending on the details of the specific implementation. Furthermore, any of the functionalities of the CPU 102 may be partially, or entirely, implemented in hardware and/or in a processor. For example, the functionality may be implemented with an application specific integrated circuit, in logic implemented in a processor, in logic implemented in a specialized graphics processing unit, or in any other device.

The present techniques correct the error that is introduced by an assumption that the sound arrives to the microphone array as a planar wave. The distance and direction of the sound source can be derived by combining information from a 3D camera and the microphone beamformer. As used herein, a beamformer is a system that performs spatial signal processing with an array of transmitters or receivers. A correction term, such as an adaptive microphone-specific delay term, can be calculated from the sound source distance information for each of the microphones in the array. Microphone-specific delay, as used herein, refers to the delay that occurs as a result of the assumption that sound arrives to the microphone array as a planar wave instead of a spherical wave. After applying the delays to the microphone signals, the beamformer processing is executed. In embodiments, atmospheric sound absorption may be compensated for using suitable filtering techniques. The filtering is defined using the physical parameters affecting sound absorption characteristics in air, such as the distance to the sound source, ambient air pressure and humidity. These can be measured from the device, pulled from a remote data source (e.g., a weather service) or historical data given the geographical position of the audio source.

FIG. 2 is an illustration of audio emissions from an audio source. As illustrated, the audio source 202 can be located a total distance D away from a microphone array 204. The microphone array 204 includes five microphones 204A, 204B, 204C, 204D, and 204E. Although a particular number of microphones are illustrated, any number of microphones may be included in the microphone array. The audio from the audio source is propagated in all directions. In particular, audio waves travel in a direction 206 from the audio source 202 toward the microphone array 204. Planar audio waves 210, including waves 210A, 210B, 210C, 210D, 210E, and 210F are illustrated. Additionally, spherical audio waves 212 are illustrated. Specifically, spherical audio waves 212A, 212B, 212C, 212D, 212E, and 212F are illustrated.

At points along the propagation path 206 that are closer to the audio source 202, the difference d 208 between the planar sound wave 210 and the corresponding spherical sound wave 212 is large. For example, the difference dl between the planar wave 210B and the spherical wave 212B is large—that is, the spherical wave 212B does not convey sound information according to the planar wave model 210B. Put another way, the planar wave model is not usable when the sound source 202 is close to the microphone array 204. The difference d5 illustrates a difference between the audio information conveyed by a planar audio wave model and a spherical wave model at the microphone array. Specifically, at the microphone array 204, as half of the planar wave has passed the microphone array, and the spherical array has barely approached the microphone array. The difference d between the planar and spherical sound wave models becomes bigger when the sound source is closer to the microphone array (as an example, d1 is bigger than d5). Thus, when the sound source is closer to the microphone array, error introduced by assuming that the sound wave is planar instead of spherical is large. When the sound source is farther from the microphone array, error introduced by assuming that the sound wave is planar instead of spherical is smaller. Accordingly, there is a distance dependent error that is introduced into a beamforming algorithm that operates using a planar sound wave model instead of a spherical sound wave model.

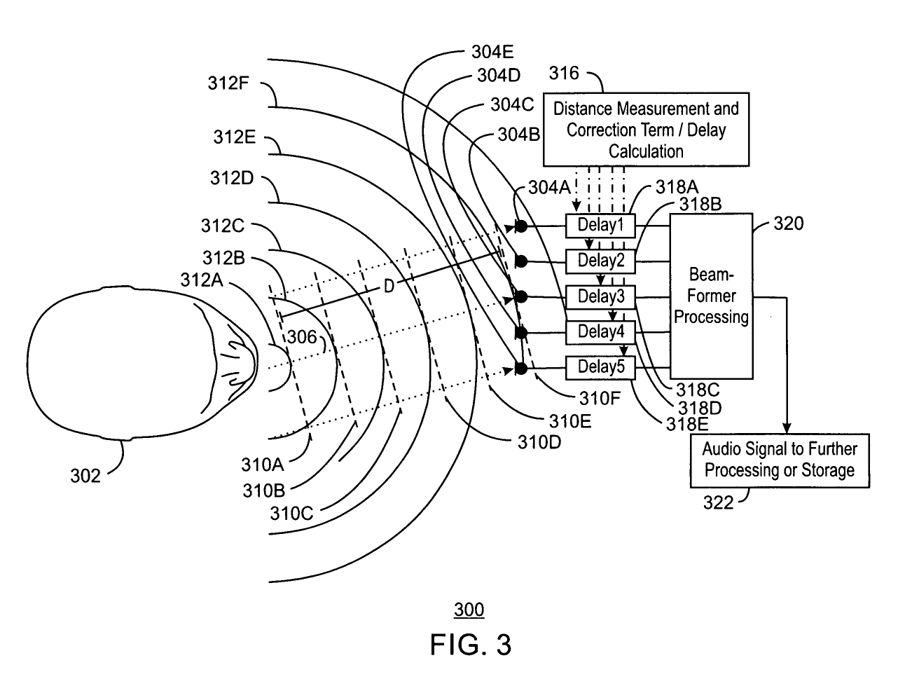

Since information captured by a 3D camera can be used to measure the distance between the capturing device and the sound source, the abovementioned error, which is a function of the distance from the sound source, can be corrected, compensated for, or counterbalanced. The correction is calculated algebraically from the distance of the sound source and it is determined individually for each of the microphones in the array. In practice, the error correction is carried out by applying an appropriate delay to each of the microphone signals before the beamformer processing. The signal processing is illustrated in FIG. 3.

FIG. 3 is an illustration of beamforming error correction. As illustrated, the audio source 302 can be located a total distance D away from a microphone array 304. The microphone array 304 includes five microphones 304A, 304B, 304C, 304D, and 304E. Although a particular number of microphones are illustrated, any number of microphones may be included in the microphone array. The audio from the audio source is propagated in all directions, including a direction 306, from the audio source 302 toward the microphone array 304. Planar audio waves 310A, 310B, 310C, 310D, 310E, and 310F are illustrated. Additionally, spherical audio waves 312 are illustrated. Specifically, planar audio waves 312A, 312B, 312C, 312D, 312E, and 312F are illustrated.

As each spherical wave approaches each microphone of the microphone array 304, a delay can be applied to each microphone to counteract a planar wave model implemented by beamformer processing 320. In particular, a distance measurement and correction term delay calculation is performed at block 316. The delay correction terms calculated at block 316 may be applied to each microphone of the microphone array at blocks 304A, 304B, 304C, 304D, and 304E. In particular, a delay correction or compensation term 318A, 318B, 318C, 318D, and 318E is applied to each microphone 304A, 304B, 304C, 304D, and 304E, respectively. The delay correction term is microphone dependent, and is calculated for each microphone of the microphone array. After the delay correction term is applied to the received audio signal at from each microphone of the microphone array, each signal is sent to the beamformer processing at block 320. In embodiments, beamformer processing includes applying constructive interference to portions of the signal that are to be amplified, and applying destructive interference to other portions of the audio signal. After beamforming has been applied, the audio signal can be sent for further processing or storage at block 322.

For ease of description, the exemplary microphone array in the previous figures is one-dimensional. However, the same techniques can be similarly used for 2- or 3-dimensional microphone arrays as well. The microphone array can also consist of any number of microphones although the figures present the example for five microphones. In embodiments, that the correction applied to the sound waves may use fractional delay filters in order to apply the delay accurately. The delay may be applied frequency dependently, if certain frequencies are observed to arrive from a point source and other frequencies from a planar source. This may be done by exploiting a finite impulse response (FIR) filter, infinite impulse response (IIR) filter, filter bank, fast Fourier transform (FFT), or other similar processing. The separation between point and planar source can be carried out, for instance, by scanning the size of the sound source with beam steering.

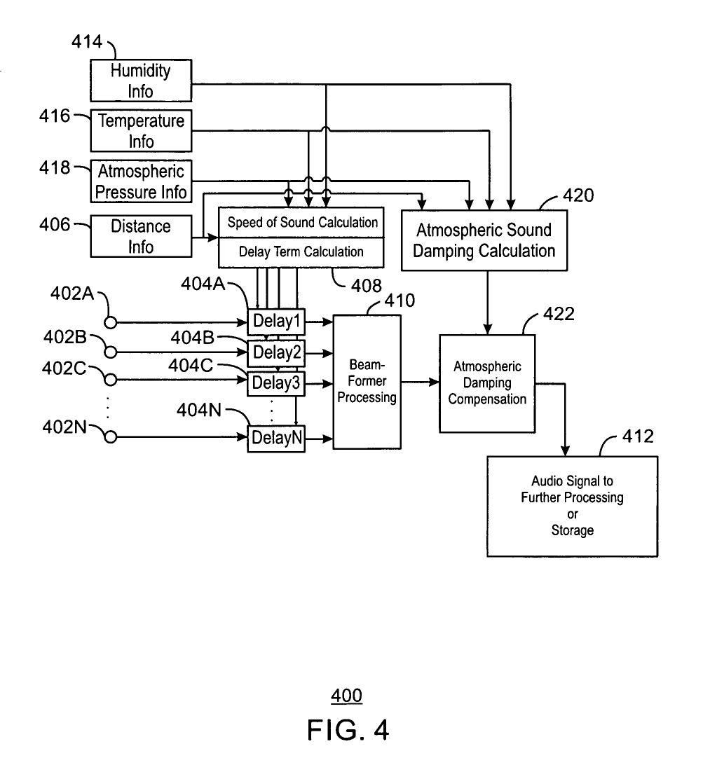

FIG. 4 is a block diagram of beamforming incorporating environmental information. In particular, the distance dependent microphone delay correction may be combined with atmospheric sound absorption compensation.

The microphone array 402 includes any number of microphones 402A, 402B, 402C, to 402N. As each spherical wave approaches each microphone of the microphone array 402, a delay can be applied to the wave received at each microphone. Accordingly, a delay 404A, 404B, 404C, to 404N is applied to the audio signals collected by the microphones 402A, 402B, 402C, to 402N, respectively. Distance information is captured at block 406, and delay term is calculated at block 408 using the distance information 406. In embodiments, the distance information may be captured by an image capture mechanism, a time of flight sensor, an infrared sensor, a radar, and the like. After the calculated delay is applied to the received audio signal at from each microphone of the microphone array, each signal is sent to a beamformer for processing at block 410. After beamforming has been applied, the audio signal can be sent for further processing or storage at block 412.

In addition to the delay term calculation at block 408, additional calculations may be performed to account for environmental conditions at block 408. The additional environmental calculations can be used to mitigate the delay experienced at each microphone of the microphone array. In embodiments, a speed of sound calculation may be performed on data from a sensor hub at block 408. The diagram 400 also includes processing for environmental information such as a humidity information block 414, a temperature information block 416, and an atmospheric pressure information block 418. While particular environmental characteristics are described, any environmental information can be used to optimize the delay terms applied to the microphone array. An additional atmospheric sound damping compensation calculation may be performed at block 420. The atmospheric sound damping compensation 420 may be used to determine the attenuation of high frequencies of the sound wave based on environmental conditions. A compensation term is defined to account for the attenuation of sounds at high frequencies. At block 422, the compensation term may be calculated and applied to the beamformer processed audio signal, and the compensated signal may be sent to further processing or storage at block 412.

The speed of sound in the air, as calculated at block 408, defines the required delay in seconds. The delay terms may be defined using a constant value for the speed of sound. Alternatively, to achieve a more precise value, the speed can be derived from one or more of the parameters affecting it, such as temperature, relative humidity, and atmospheric pressure. Since the beamforming enables far-field sound capture feasible, the compensation of the atmospheric sound absorption becomes sensible. Devices comprising a 3D camera and a microphone array may have sensors for measuring either some or all of the parameters (e.g. temperature, relative humidity, and atmospheric pressure), which define the frequency-dependent sound absorption (damping) of the air. These parameters can be measured from the device, pulled from a remote data source (e.g., a weather service) or obtained from historical data given the geographical position. It is possible to define and compensate the atmospheric damping, when the sound source distance is known. Even in a case where the sensors are not available, or only some of them are, atmospheric information according to a geographic location may be used. The atmospheric compensation may lead to improved performance if predefined constants for the mentioned parameters are used. In embodiments, the compensation for the high frequency attenuation can be performed by processing the sound signal with a filter, which is inverse to the atmospheric attenuation. This results in the high frequencies being boosted compared to the low frequencies.

In embodiments, sound from different directions may be treated differently when multiple beams are formed simultaneously or if the sound arriving from a certain direction is originated close to the microphone array. If the sound from another direction arrives from a further source, the first source may utilize the described delays for the microphone signals and the second source may omit the delays. Additionally, in embodiments, the positional/distance information used in the delay term calculation may be received from other devices. For example, routers may be used to determine the location of a mobile device in a home or a room. A router, as used herein, may be a wireless network router such as one that couples with a WiFi or a 3G/4G network. The routers can then be used to send positional and distance information to the mobile device.

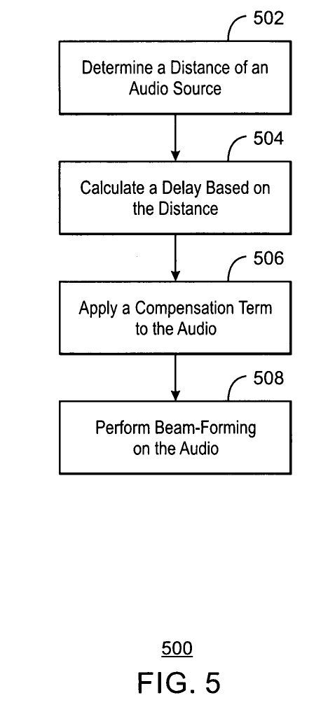

FIG. 5 is a process flow diagram of beamforming using distance information. At block 502, a distance of an audio source is determined. The distance of the audio source from the microphone array may be determine by an image capture mechanism or any other sensor or device capable of providing distance information. At block 504, a delay is calculated based on the determined distance. At block 506, a compensation term may be applied to the audio captured by the microphone array. The compensation term may be based, at least partially on the distance. The compensation term may also include environmental conditions, and include an atmospheric damping compensation term. At block 508, beamforming may be performed on the compensated audio signal. In this manner, the audio beamforming enables air absorption compensation, near-field compensation, and the high frequencies are boosted compared to the low frequencies of the audio.

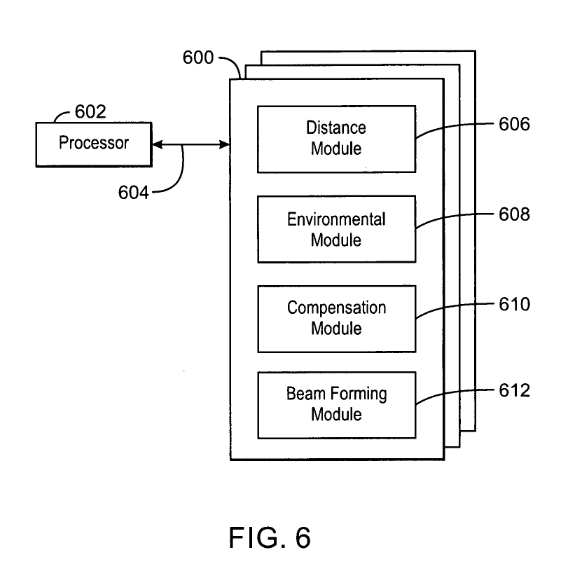

FIG. 6 is a block diagram showing a medium 600 that contains logic for beamforming using distance information. The medium 600 may be a computer-readable medium, including a non-transitory medium that stores code that can be accessed by a processor 602 over a computer bus 604. For example, the computer-readable medium 600 can be volatile or non-volatile data storage device. The medium 600 can also be a logic unit, such as an Application Specific Integrated Circuit (ASIC), a Field Programmable Gate Array (FPGA), or an arrangement of logic gates implemented in one or more integrated circuits, for example.

The medium 600 may include modules 606-612 configured to perform the techniques described herein. For example, a distance module 606 may be configured to determine a distance of an audio source from a microphone array. An environmental module 608 may be configured to determine a compensation term based on environmental factors. A compensation module 610 may be to apply a distance term and/or an environmental compensation term to the captured audio. A beamforming module may be used to apply beamforming to the audio. In some embodiments, the modules 607-612 may be modules of computer code configured to direct the operations of the processor 602.

The block diagram of FIG. 6 is not intended to indicate that the medium 600 is to include all of the components shown in FIG. 6. Further, the medium 600 may include any number of additional components not shown in FIG. 6, depending on the details of the specific implementation.

Example 1 is an apparatus. The apparatus includes one or more microphones to receive audio signals; a distance detector to determine a distance of an audio source from the one or more microphones; a delay detector to calculate a delay term based on the distance determined by the audio source; and a processor to perform audio beamforming on the audio signals combined with the delay term.

Example 2 includes the apparatus of example 1, including or excluding optional features. In this example, the delay term is to counteract an error in the audio beamforming via a delay filter. Optionally, the error is dependent on the distance and a waveform model used by the audio beamforming.

Example 3 includes the apparatus of any one of examples 1 to 2, including or excluding optional features. In this example, the delay term is to correct an error that is based, at least partially, on an assumption that the audio signals arrive to the one or more microphones as a planar wave.

Example 4 includes the apparatus of any one of examples 1 to 3, including or excluding optional features. In this example, the delay detector is to calculate the delay term using data from an infrared sensor, a time of flight sensor, a three dimensional camera, or any combination thereof.

Example 5 includes the apparatus of any one of examples 1 to 4, including or excluding optional features. In this example, the apparatus includes a sensor hub, wherein the sensor hub is to measure atmospheric conditions, and the atmospheric conditions are combined with the audio signals and the delay term prior to audio beamforming. Optionally, the sensor hub comprises a humidity information, a temperature information, or pressure information. Optionally, data from the sensor hub is used to calculate an atmospheric sound damping calculation.

Example 6 includes the apparatus of any one of examples 1 to 5, including or excluding optional features. In this example, distance detector is an external device used to calculate distance.

Example 7 includes the apparatus of any one of examples 1 to 6, including or excluding optional features. In this example, the apparatus includes an environmental compensator to boost a high frequency of the audio signal.

Example 8 is a method. The method includes determining a distance of an audio source; calculating a delay based on the distance; applying a compensation term to audio from the audio source, wherein the compensation term is based, at least partially on the distance; and performing beamforming on the compensated audio.

Example 9 includes the method of example 8, including or excluding optional features. In this example, the compensation term is applied to the audio via a filter.

Example 10 includes the method of any one of examples 8 to 9, including or excluding optional features. In this example, the compensation term is counteract an error associated with a spherical waveform processed by a planar waveform model.

Example 11 includes the method of any one of examples 8 to 10, including or excluding optional features. In this example, the distance is calculated using an infrared sensor, a time of flight sensor, a three-dimensional camera, or any combination thereof.

Example 12 includes the method of any one of examples 8 to 11, including or excluding optional features. In this example, the method includes a sensor hub, wherein the sensor hub is to capture information on environmental conditions.

Example 13 includes the method of any one of examples 8 to 12, including or excluding optional features. In this example, the compensation term is based, at least partially, on a humidity information, a temperature information, a pressure information, or any combination thereof.

Example 14 includes the method of any one of examples 8 to 13, including or excluding optional features. In this example, the compensation term is based, at least partially, on an atmospheric sound damping calculation.

Example 15 includes the method of any one of examples 8 to 14, including or excluding optional features. In this example, the distance of the audio source is determined with respect to a microphone array.

Example 16 includes the method of any one of examples 8 to 15, including or excluding optional features. In this example, a filter is applied to the audio to alter physical characteristics of the audio.

Example 17 includes the method of any one of examples 8 to 16, including or excluding optional features. In this example, the compensation term is an adaptive microphone-specific delay.

Example 18 is a tangible, non-transitory, computer-readable medium. The computer-readable medium includes instructions that direct the processor to determine a distance of an audio source; calculate a delay based on the distance; apply a compensation term to audio from the audio source, wherein the compensation term is based, at least partially on the distance; and perform beamforming on the compensated audio.

Example 19 includes the computer-readable medium of example 18, including or excluding optional features. In this example, the compensation term is applied to the audio via a filter.

Example 20 includes the computer-readable medium of any one of examples 18 to 19, including or excluding optional features. In this example, the compensation term is counteract an error associated with a spherical waveform processed by a planar waveform model.

Example 21 includes the computer-readable medium of any one of examples 18 to 20, including or excluding optional features. In this example, the distance is calculated using an infrared sensor, a time of flight sensor, a three-dimensional camera, or any combination thereof.

Example 22 includes the computer-readable medium of any one of examples 18 to 21, including or excluding optional features. In this example, the computer-readable medium includes a sensor hub, wherein the sensor hub is to capture information on environmental conditions.

Example 23 includes the computer-readable medium of any one of examples 18 to 22, including or excluding optional features. In this example, the compensation term is based, at least partially, on a humidity information, a temperature information, a pressure information, or any combination thereof.

Example 24 includes the computer-readable medium of any one of examples 18 to 23, including or excluding optional features. In this example, the compensation term is based, at least partially, on an atmospheric sound damping calculation.

Example 25 includes the computer-readable medium of any one of examples 18 to 24, including or excluding optional features. In this example, the distance of the audio source is determined with respect to a microphone array.

Example 26 includes the computer-readable medium of any one of examples 18 to 25, including or excluding optional features. In this example, a filter is applied to the audio to alter physical characteristics of the audio.

Example 27 includes the computer-readable medium of any one of examples 18 to 26, including or excluding optional features. In this example, the compensation term is an adaptive microphone-specific delay.

Example 28 is a system. The system includes instructions that direct the processor to one or more microphones to receive audio signals; a plurality of sensors to obtain data representing a distance of an audio source and environmental conditions, wherein the audio source is to produce the audio signals; a beamformer to perform audio beamforming of the audio signals combined with a correction term; a processor, wherein the processor is coupled with the one or more microphones, the plurality of sensors, and the beamformer, and is to execute instructions that cause the processor to calculate the delay term of the audio signals based upon, at least in part, the distance of the audio source.

Example 29 includes the system of example 28, including or excluding optional features. In this example, the audio source is determined based on an initial beamformer processing.

Example 30 includes the system of any one of examples 28 to 29, including or excluding optional features. In this example, a distance and direction of the audio source is derived for the data from the plurality of sensors and the beamfomer.

Example 31 includes the system of any one of examples 28 to 30, including or excluding optional features. In this example, the beamformer comprises one or more transmitters or receivers coupled with a microcontroller.

Example 32 includes the system of any one of examples 28 to 31, including or excluding optional features. In this example, the delay term is to correct error caused by a microphone specific delay.

Example 33 includes the system of any one of examples 28 to 32, including or excluding optional features. In this example, the delay term is combined with the audio signals via a filter.

Example 34 includes the system of any one of examples 28 to 33, including or excluding optional features. In this example, the delay term is based upon, at least partially, a spherical waveform model.

Example 35 includes the system of any one of examples 28 to 34, including or excluding optional features. In this example, the plurality of sensors include an infrared sensor, a time of flight sensor, an imaging sensor, or any combination thereof.

Example 36 includes the system of any one of examples 28 to 35, including or excluding optional features. In this example, the plurality of sensors is to measure humidity information, temperature information, or pressure information.

Example 37 includes the system of any one of examples 28 to 36, including or excluding optional features. In this example, the beamformer is to perform audio beamforming of the audio signals combined with a correction term and an atmospheric sound damping calculation.

Example 38 is an apparatus. The apparatus includes instructions that direct the processor to one or more microphones to receive audio signals; a distance detector to determine a distance of an audio source from the one or more microphones; a means to counteract microphone specific delay; and a processor to perform audio beamforming on the audio signals combined with the means to counteract microphone specific delay.

Example 39 includes the apparatus of example 38, including or excluding optional features. In this example, the means to counteract microphone specific delay is to counteract an error in the audio beamforming via a delay filter. Optionally, the error is dependent on the distance and a waveform model used by the audio beamforming.

Example 40 includes the apparatus of any one of examples 38 to 39, including or excluding optional features. In this example, the means to counteract microphone specific delay is to correct an error that is based, at least partially, on an assumption that the audio signals arrive to the one or more microphones as a planar wave.

Example 41 includes the apparatus of any one of examples 38 to 40, including or excluding optional features. In this example, the means to counteract microphone specific delay is to calculate a delay term using data from an infrared sensor, a time of flight sensor, a three dimensional camera, or any combination thereof.

Example 42 includes the apparatus of any one of examples 38 to 41, including or excluding optional features. In this example, the apparatus includes a sensor hub, wherein the sensor hub is to measure atmospheric conditions, and the atmospheric conditions are combined with the audio signals and the means to counteract microphone specific delay prior to audio beamforming. Optionally, the sensor hub comprises a humidity information, a temperature information, or pressure information. Optionally, data from the sensor hub is used to calculate an atmospheric sound damping calculation.

Example 43 includes the apparatus of any one of examples 38 to 42, including or excluding optional features. In this example, distance detector is an external device used to calculate distance.

Example 44 includes the apparatus of any one of examples 38 to 43, including or excluding optional features. In this example, the apparatus includes an environmental compensator to boost a high frequency of the audio signal.

Some embodiments may be implemented in one or a combination of hardware, firmware, and software. Some embodiments may also be implemented as instructions stored on the tangible, non-transitory, machine-readable medium, which may be read and executed by a computing platform to perform the operations described. In addition, a machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

1. An apparatus, comprising:
one or more microphones to receive audio signals;
a distance detector to determine a distance of an audio source from the one or more microphones;
a delay detector to calculate a delay term based on the determined distance, wherein the distance is to indicate an error between a planar audio wave model and a spherical sound wave model and the delay term is to correct the error; and
a processor to combine the audio signals with the delay term and perform audio beamforming on the audio signals combined with the delay term.

2. (canceled)

3. The apparatus of claim 2, wherein the distance detector is a 3D camera that is to measure the distance of the audio source.

4. The apparatus of claim 1, wherein the delay detector is to calculate the delay term such that the delay term is to correct an error that is based, at least partially, on an assumption that the audio signals arrive to the one or more microphones as a planar wave.

5. The apparatus of claim 1, wherein the delay detector is to calculate the delay term using data from an infrared sensor, a time of flight sensor, a three dimensional camera, or any combination thereof.

6. The apparatus of claim 1, comprising a sensor hub, wherein the sensor hub is to measure atmospheric conditions, and the processor is to combine the atmospheric conditions with the audio signals and the delay term prior to audio beamforming.

7. The apparatus of claim 6, wherein the sensor hub comprises a humidity information, a temperature information, or pressure information.

8. The apparatus of claim 6, wherein data from the sensor hub is used by the processor to calculate an atmospheric sound damping calculation.

9. The apparatus of claim 1, wherein the distance detector is an external device that is to determine distance.

10. The apparatus of claim 1, comprising an environmental compensator to boost a high frequency of the audio signals.

11. A method, comprising:
determining a distance of an audio source;
calculating a delay based on the distance;
applying a compensation term to audio from the audio source, wherein the compensation term is a microphone-specific delay term and is based, at least partially on the distance; and
performing beamforming on the audio after the compensation term is applied to the audio.

12. The method of claim 11, wherein the compensation term is applied to the audio via a filter.

13. The method of claim 11, wherein the compensation term is to counteract an error associated with a spherical waveform processed by a planar waveform model.

14. The method of claim 11, wherein the distance is calculated using an infrared sensor, a time of flight sensor, a three-dimensional camera, or any combination thereof.

15. The method of claim 11, comprising a sensor hub, wherein the sensor hub is to capture information on environmental conditions.

16. The method of claim 11, wherein the compensation term is based, at least partially, on a humidity information, a temperature information, a pressure information, or any combination thereof.

17. A tangible, non-transitory, computer-readable medium comprising instructions that, when executed by a processor, direct the processor to:
determine a distance of an audio source;
calculate a delay based on the distance;
apply a compensation term to audio from the audio source, wherein the compensation term is a microphone-specific delay term and is based, at least partially on the distance; and
perform beamforming on the compensated audio.

18. The tangible, non-transitory, computer-readable medium of claim 17, wherein the compensation term is applied to the audio via a filter.

19. The tangible, non-transitory, computer-readable medium of claim 17, wherein the compensation term is to counteract an error associated with a spherical waveform processed by a planar waveform model.

20. The tangible, non-transitory, computer-readable medium of claim 17, wherein the distance is calculated using an infrared sensor, a time of flight sensor, a three-dimensional camera, or any combination thereof.

21. A system, comprising:
one or more microphones to receive audio signals;
a plurality of sensors to obtain data representing a distance of an audio source and environmental conditions, wherein the audio source is to produce the audio signals; and
a processor, wherein the processor is coupled with the one or more microphones, the plurality of sensors, and the beamformer, and is to execute instructions that cause the processor to combine the audio signals with the correction term and to calculate a correction term of the audio signals based upon, at least in part, the distance of the audio source and a difference between a planar audio wave model and a spherical sound wave model;
a beamformer to perform audio beamforming of the audio signals combined with the correction term.

22. The system of claim 21, wherein the beamformer is to determine the audio source based on an initial beamformer processing.

23. The system of claim 21, wherein the processor derives a distance and direction of the audio source based on the data from the plurality of sensors and the beamformer.

24. The system of claim 21, wherein the beamformer comprises one or more transmitters or receivers coupled with a microcontroller.

25. The system of claim 21, wherein the delay term is to correct error caused by a microphone specific delay
